(19) United States
(12) Patent Application Publication
(10) Pub. No.: US 2021/0017679 A1
(43) Pub. Date: Jan. 21, 2021

(54) NATURAL, REGENERATED, SUSTAINABLE FABRIC AND METHOD

(71) Applicant: Mahendra Poddar, Mumbai (IN)

(72) Inventor: Mahendra Poddar, Mumbai (IN)

(21) Appl. No.: 16/515,200

(22) Filed: Jul. 18, 2019

(51) Int. Cl. D03D 15/00; B32B 5/26; B32B 5/02

(52) U.S. Cl. CPC D03D 15/0027; B32B 2437/00; B32B 5/024; B32B 5/26

(57) ABSTRACT

A natural, regenerated, sustainable fabric is fabricated of a primary yarn and a secondary yarn. The primary yarn is twisted from shredded recycled jeans and natural fibres. The secondary yarn includes natural fibres. The primary and secondary yarns are woven to constitute a warp yarn and a weft yarn of the fabric. The method of producing the fabric includes the steps of shredding post consumer used jeans into fibre, blending the shredded post consumer jeans fibre with either dobe dyed or undyed natural fibre, the fibre selected from the class of fibres including Tencel®, cotton, and viscose, spinning yarn from this blended fibre into a single yarn, weaving fabric from the blended yarn with other natural yard into fabric, washing the fabric to remove impurities and treating and recycling the water, and using the fabric to make textile products.

### BACKGROUND OF THE INVENTION

### Field of the Invention

The present invention relates to a natural, regenerated, sustainable fabric and more particularly pertains to a natural, regenerated, sustainable fabric and method of production that allows making home textile products of a fabric that is natural, regenerated, and sustainable.

### Description of the Prior Art

The use of fabrics and methods of producing fabrics of known designs and configurations is known in the prior art. More specifically, fabrics and methods of producing fabrics of known designs and configurations previously devised and utilized for the purpose of making home textile products are known to consist basically of familiar, expected, and obvious structural configurations, notwithstanding the myriad of designs encompassed by the crowded prior art which has been developed for the fulfillment of countless objectives and requirements.

While these devices fulfill their respective, particular objectives and requirements, they do not describe a natural, regenerated, sustainable fabric and method of production that allows making home textile products of a fabric that is natural, regenerated, and sustainable.

In this respect, the natural, regenerated, sustainable fabric according to the present invention substantially departs from the conventional concepts and designs of the prior art, and in doing so provides an apparatus and method primarily developed for a the production of a natural, regenerated, sustainable fabric that allows making home textile products of a fabric that is natural, regenerated, and sustainable.

Therefore, it can be appreciated that there exists a continuing need for a new and improved natural, regenerated, sustainable fabric which can be used for the production of a natural, regenerated, sustainable fabric and method of production that allows making home textile products of a fabric that is natural, regenerated, and sustainable. In this regard, the present invention substantially fulfills this need.

### SUMMARY OF THE INVENTION

In view of the disadvantages inherent in the known types of fabrics and methods of producing fabrics of known designs and configurations now present in the prior art, the present invention provides an improved natural, regenerated, sustainable fabric. As such, the general purpose of the present invention, which will be described subsequently in greater detail, is to provide a new and improved natural, regenerated, sustainable fabric and method which has all the advantages of the prior art and none of the disadvantages.

To attain this, from a broad perspective, the present invention essentially comprises a natural, regenerated, sustainable fabric fabricated of a primary yarn and a secondary yarn. The primary yarn is twisted from shredded recycled jeans and natural fibres. The secondary yarn includes natural fibres. The primary and secondary yarns are woven to constitute a warp yarn and a weft yarn of the fabric. The method of producing the fabric includes the steps of: shredding post consumer used jeans into fibre, blending the shredded post consumer jeans fibre with either dobe dyed or undyed natural fibre, the fibre selected from the class of fibres including Tencel®, cotton, and viscose; spinning yarn from this blended fibre into a single yarn; weaving fabric from the blended yarn with other natural yarn into fabric; washing the fabric to remove impurities and treating and recycling the water; and using the fabric to make textile products.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved natural, regenerated, sustainable fabric which has all of the advantages of the prior art fabrics and methods of producing fabrics of known designs and configurations and none of the disadvantages.

It is another object of the present invention to provide a new and improved natural, regenerated, sustainable fabric which may be easily and efficiently manufactured and marketed.

It is a further object of the present invention to provide a new and improved natural, regenerated, sustainable fabric which is of durable and reliable constructions.

An even further object of the present invention is to provide a new and improved natural, regenerated, sustainable fabric which is susceptible of a low cost of manufacture with regard to both materials and labor, and which accordingly is then susceptible of low prices of sale to the consuming public, thereby making such natural, regenerated, sustainable fabric economically available to the buying public.

Lastly, it is an object of the present invention to provide a natural, regenerated, sustainable fabric and method for making textile products of a fabric that is natural, regenerated, and sustainable.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram showing the steps in the method of creating fabric for home textile products, the method being in accordance with the principles of the present invention.

FIG. 2 is a reduced illustration of post consumer used jeans and an enlarged showing of shredded recycled jeans.

FIG. 3 is an illustration of shredded recycled jeans being twisted into yarn.

FIG. 4 is an illustration of primary yarn being twisted from a shredded recycled jeans yarn and a yarn of natural fibres.

FIG. 5 is an enlarged showing of a fabric woven of warp yarn and weft yarn.

FIG. 6 is a perspective illustration of home textile products, bedding, pillows, throws, curtains, kitchen fabrics, and the like made of the fabric of the present invention.

The same reference numerals refer to the same parts throughout the various Figures.

### DESCRIPTION OF THE PREFERRED EMBODIMENT

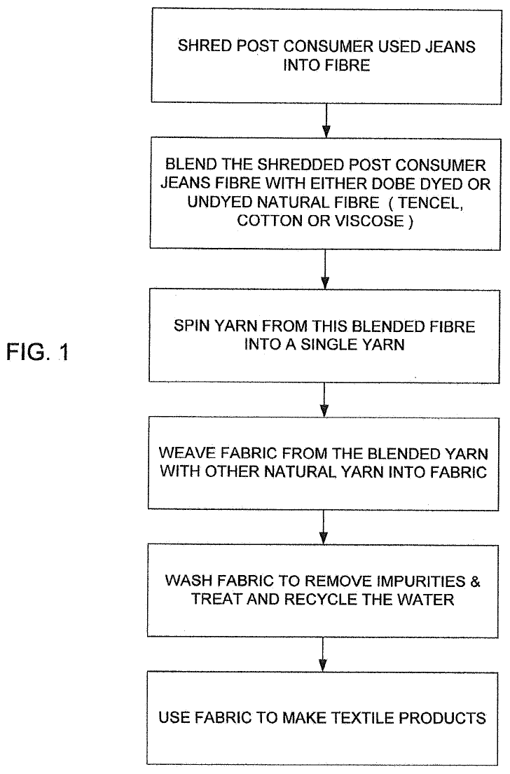

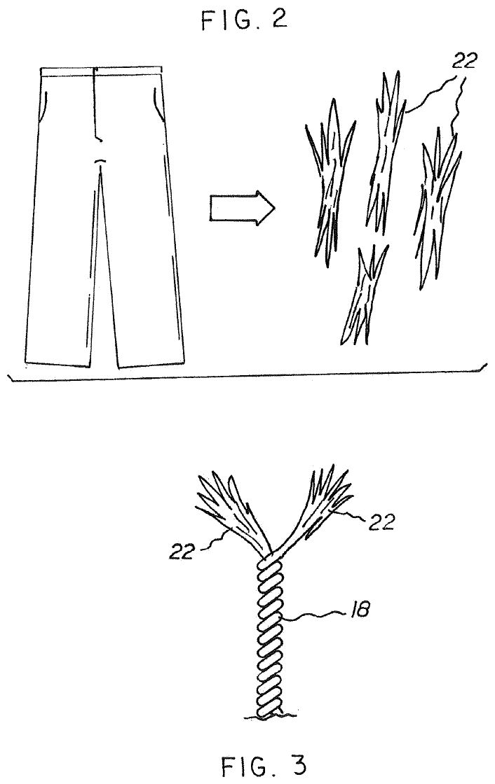

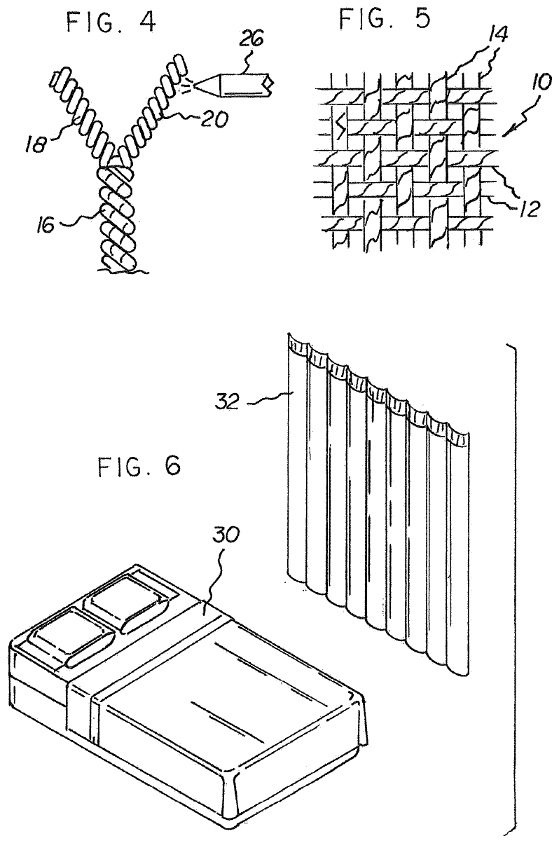

With reference now to the drawings, and in particular to FIG. 1 thereof, the preferred embodiment of the new and improved natural, regenerated, sustainable fabric embodying the principles and concepts of the present invention and generally designated by the reference numeral 10 will be described.

The present invention, the natural, regenerated, sustainable fabric 10 is comprised of a plurality of components. Such components in their broadest context include a primary yarn and a secondary yarn woven to constitute a warp yarn and a weft yarn of the fabric. Such components are individually configured and correlated with respect to each other so as to attain the desired objective.

From a specific perspective, the invention of the present application is a fabric 10 for use in making home textile products. The products include bedding 30, pillows, throws, curtains 32, kitchen fabrics, and the like. The fabric is natural, regenerated, and sustainable. The fabric is fabricated of a primary yarn 16 and a secondary yarn. The primary yarn is twisted from shredded recycled jeans 18 and natural fibres 20. The secondary yarn includes natural fibres. The primary yarn and the secondary yarn are woven of a warp yarn 14 and weft yarn 12. The weft yarn is a blended yarn twisted from a threaded recycled yarn 18 and natural fibres 20. The primary yarn originated from shredded recycled pre-twisted jeans 22 and natural fibres. The secondary yarn is formed of natural fibres. The natural fibres are chosen from the class of natural fibres including cotton, Tencel®, viscose, and blends thereof. The warp yarn is formed of a natural fibre. The natural fibre is chosen from the class of natural fibres including cotton, Tencel®, viscose, and blends thereof. The natural fibres of the weft yarn are dobe dyed 26 during the twisting of the primary yarn and the secondary yarn. The shredded recycled jeans in the primary yarn are from 8 ne and 40 ne. The shredded recycled jeans in the primary yarn are from 15 percent and 40 percent of the primary yarn.

The present invention includes a method of creating a fabric woven of a warp yarn and weft yarn. The method includes the following steps. The first step is shredding post consumer used jeans into fibre. The next step is blending the shredded post consumer jeans fibre with either dobe dyed or undyed natural fibre. The fibre is selected from the class of fibres including Tencel®, cotton, and viscose. The next step is spinning yarn from this blended fibre into a single yarn. The next step is weaving fabric from the blended yarn with other natural yard into fabric. The next step is washing the fabric to remove impurities and treating and recycling the water. The final step is using the fabric to make textile products.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A natural, regenerated, sustainable fabric fabricated of a primary yarn and a secondary yarn, the primary yarn being twisted from shredded recycled jeans and natural fibres, the secondary yarn including natural fibres, the primary yarn and the secondary yarn being woven to constitute a warp yarn and weft yarn of the fabric.

2. The fabric as set forth in claim 1 wherein the shredded recycled jeans in the primary yarn is from 8 ne and 40 ne.

3. The fabric as set forth in claim 1 wherein the shredded recycled jeans in the primary yarn is from 15 percent and 35 percent of the primary yarn.

4. The fabric as set forth in claim 1 wherein the natural fibres of the secondary yarn are chosen from the class of natural fibres including cotton, Tencel®, viscose, and blends thereof.

5. The fabric as set forth in claim 1 wherein the warp yarn is the same as the weft yarn.

6. The fabric as set forth in claim 1 wherein the warp yarn is formed solely of natural fibres.

7. The fabric as set forth in claim 1 wherein the natural fibres are dobe dyed during the twisting of the primary yarn.

8. A fabric (10) for use in making home textile products including bedding (30), pillows, throws, curtains (32), kitchen fabrics, and the like, the fabric being natural, regenerated, sustainable, the fabric being fabricated of primary yarn (16) and secondary yarn (14), the primary yarn being twisted from shredded recycled jeans (18) and natural fibres (20), the secondary yarn including natural fibres, the primary yarn and the secondary yarn being woven of a warp yarn (14) and weft yarn (12), the weft yarn being a blended yarn twisted from a threaded recycled yarn (18) and natural fibres (20), the primary yarn originating from shredded recycled pre-twisted jeans and natural fibres (22), the secondary yarn being formed of natural fibres chosen from the class of natural fibres including cotton and Tencel® and viscose and blends thereof, the warp yarn being formed of a natural fibre chosen from the class of natural fibres including cotton and Tencel® and viscose and blends thereof, the natural fibres of the weft yarn being dobe dyed (26) during the twisting of the primary yarn and the secondary yarn, the shredded recycled jeans in the primary yarn being from 8 ne and 40 ne, the shredded recycled jeans in the primary yarn being from 15 percent and 35 percent of the primary yarn.

9. A method of creating a fabric woven of a warp yarn and weft yarn, the method including the steps of:
shredding post consumer used jeans into fibre;
blending the shredded post consumer jeans fibre with either dobe dyed or undyed natural fibre, the fibre selected from the class of fibres including Tencel®, cotton, and viscose;
spinning yarn from this blended fibre into a single yarn;
weaving fabric from the blended yarn with other natural yard into fabric;
washing the fabric to remove impurities and treating and recycling the water; and
using the fabric to make textile product.
